(19) United States
(12) Patent Application Publication
(10) Pub. No.: US 2013/0022303 A1
(43) Pub. Date: Jan. 24, 2013

(54) ANGULAR CONTACT BEARING ASSEMBLY WITH CLEARANCE CONTROL

(71) Applicant: Todd A. Spierling, Byron, IL (US)

(72) Inventor: Todd A. Spierling, Byron, IL (US)

(21) Appl. No.: 13/185,469

(22) Filed: Jul. 18, 2011

(51) Int. Cl. F16C 19/14

(52) U.S. Cl. 384/456

(57) ABSTRACT

A bearing assembly includes a bearing outer race with a ramped outer diameter surface, a split ring wedge with a ramped inner diameter surface and a spring which axially biases the ramped inner diameter surface along the ramped outer diameter surface.

### BACKGROUND

The present disclosure relates to a bearing assembly, and more particularly to an angular contact bearing assembly.

Angular contact bearing assemblies are designed for a combination of radial and axial loading. Single-row bearings generally have high thrust capacity in one direction. Some single-row bearings are specifically designed to be duplex mounted in sets.

Angular contact bearings may use an axial preload spring to provide radial stiffness and stability to the rotational assemblies. The radial clearance between the bearing and the surrounding housing, however, is uncontrolled and may vary with machining tolerances and temperature variation. This clearance may detract from the stiffness and stability of the system, which may increase loads and reduced bearing life.

### SUMMARY

A bearing assembly according to an exemplary aspect of the present disclosure includes a bearing outer race with a ramped outer diameter surface, a split ring wedge with a ramped inner diameter surface and a spring which axially biases the ramped inner diameter surface along the ramped outer diameter surface.

A housing assembly according to an exemplary aspect of the present disclosure includes a first bearing assembly which rotationally supports a shaft within a housing along an axis of rotation, the first bearing assembly includes a split ring wedge which controls a radial clearance between the housing and the first bearing assembly.

A method of radial clearance control for a shaft within a housing according to an exemplary aspect of the present disclosure includes axially biasing a split ring wedge relative to a bearing assembly which rotationally supports a shaft within a housing along an axis of rotation.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-sectional view of a housing assembly with a set of angular contact bearing assemblies; and

FIG. 2 is a plan view of a spit ring wedge which provides a radial clearance control function to each bearing of the angular contact bearing assemblies.

### DETAILED DESCRIPTION

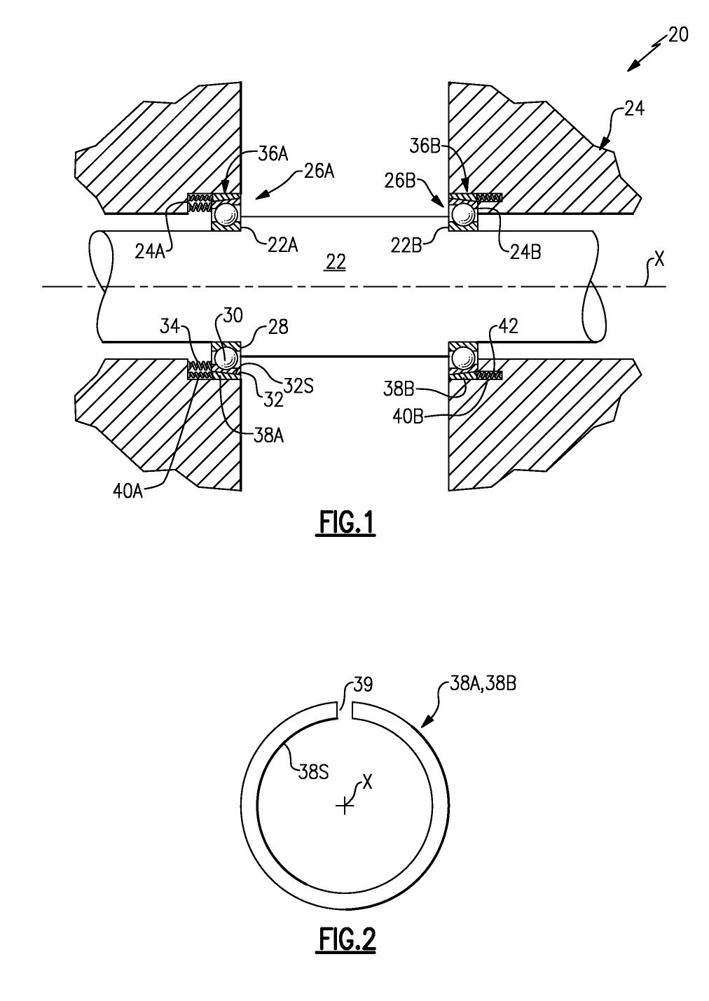

FIG. 1 schematically illustrates a housing assembly 20 that generally includes a shaft 22 mounted within a housing 24 through a first and second angular contact bearing assembly 26A, 26B. The first and second angular contact bearing assembly 26A, 26B are arranged adjacent to a first and second shoulder 22A, 22B in the shaft 22 and a first and second face 24A, 24B in the housing 24. Although the angular contact bearing assemblies 26A, 26B are arranged in a set of two at each end section of the shaft 22 in the illustrated disclosed non-limiting embodiment, it should be understood that various arrangements may alternatively or additionally be provided.

Each angular contact bearing assembly 26A, 26B generally includes an inner race 28, an outer race 32 and a multiple of bearing elements 30 therebetween. It should be understood that additional bearing components such as a cage may additionally be provided. Each outer race 32 defines an angled or ramped outer surface 32S defined along a shaft axis of rotation X. The ramped outer surface 32S are arranged in an opposed manner in that the greatest radial diameter of the ramped outer surface 32S face each other in the disclosed non-limiting embodiment.

The housing face 24A reacts a relatively large axial preload along the axis of rotation X provided by a preload spring 34 such as a multiple of coil springs, wave spring or other biasing member to provide radial stiffness and stability to the rotational shaft 22. That is, the spring 34 is located adjacent to face 24A to axially preload the first bearing assembly 26A into the shoulder 22A of the shaft 22 and the second bearing assembly 26B into the housing face 24B through the second shoulder 22B.

Each angular contact bearing assembly 26A, 26B also includes a respective first and second opposed wedge assembly 36A, 36B. Each first and second opposed wedge assembly 36A, 36B is mounted around the respective outer race 32 in an opposed manner. That is, each wedge assembly 36A, 36B are spring biased toward each other axially.

Each wedge assembly 36A, 36B generally includes a split ring wedge 38A, 38B which is biased by a respective spring 40A, 40B such as a coil spring or wave spring. Each split ring wedge 38A, 38B includes a ramped inner diameter surface 38S which matches the ramp angle of the ramped outer diameter surface 32S as well as a split 39 which permits radial expansion and contraction thereon (FIG. 2).

A spring recess 42 may be located within the housing face 24B to receive the spring 40B. That is, as the second angular contact bearing assembly 26B may abut the housing face 24B, the spring recess 42 provides a receipt location for the spring 40B as compared to spring 40A which may be adjacent to preload spring 34 to abut face 24A.

The split ring wedges 38A, 38B slide axially along the ramped outer surface 32S in response to the axial preload of springs 40A, 40B to eliminate any radial gap between the bearing outer race 32 and the surrounding housing 24 as the split ring wedge 38 opens and closes in diameter at the split 39. That is, as the housing 24 expands and contracts in response to, for example, temperature variations, each spring 40A, 40B biases the respective split ring wedge 38A, 38B such that the ramped surface 38S axially slides relative to the ramped outer surface 32S to close any radial clearance which may otherwise develop from the temperature variation.

The first and second opposed wedge assemblies 36A, 36B provides separation between the main positioning/preload function of the preload spring 34 and the radial clearance control function. This allows the axial shaft position to remain tightly controlled, yet still essentially eliminates radial clearance to accommodate machining tolerances and temperature variation in the housing 24.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A bearing assembly comprising:
a bearing outer race with an ramped outer diameter surface;
a split ring wedge with a ramped inner diameter surface; and
a spring which axially biases said ramped inner diameter surface along said ramped outer diameter surface.

2. The bearing assembly as recited in claim 1, wherein said ramped inner diameter surface is generally at the same angle as said ramped outer diameter surface.

3. The bearing assembly as recited in claim 1, further comprising a bearing inner race mounted to said bearing outer race through a multiple of bearing elements.

4. The bearing assembly as recited in claim 1, further comprising a preload spring which abuts said bearing outer race.

5. A housing assembly comprising:
a housing;
a shaft; and
a first bearing assembly which rotationally supports said shaft within said housing along an axis of rotation, said first bearing assembly includes a split ring wedge which controls a radial clearance between said housing and said first bearing assembly.

6. The housing assembly as recited in claim 5, further comprising a preload spring which abuts said first bearing assembly to bias said first bearing assembly toward a shoulder in said shaft.

7. The housing assembly as recited in claim 5, wherein said split ring wedge includes a ramped inner diameter surface adjacent to a ramped outer diameter surface of a bearing outer race.

8. The housing assembly as recited in claim 7, further comprises a spring which axially biases said ramped inner diameter surface along said ramped outer diameter surface.

9. The housing assembly as recited in claim 8, further comprising a preload spring which abuts said outer race toward a shoulder in said shaft.

10. The housing assembly as recited in claim 5, further comprising a second bearing assembly to rotationally support said shaft within said housing.

11. The housing assembly as recited in claim 10, wherein said second bearing assembly includes a second split ring wedge which controls a radial clearance between said housing and said second bearing assembly, said second split ring wedge biased toward said first bearing assembly.

12. The housing assembly as recited in claim 11, wherein said second bearing assembly abuts a face in said housing.

13. The housing assembly as recited in claim 12, further comprising a spring recess within said face to receive a spring which biases said second split ring wedge.

14. A method of radial clearance control for a shaft within a housing comprising:
axially biasing a split ring wedge relative to a bearing assembly which rotationally supports a shaft within a housing along an axis of rotation.

15. The method as recited in claim 14, further comprising sliding a ramped outer diameter surface of a bearing outer race with respect to a ramped inner diameter surface of the split ring wedge.

16. The method as recited in claim 15, further comprising changing a radial diameter of the split ring wedge.
